(19) United States
(12) Patent Application Publication
(10) Pub. No.: US 2004/0128329 A1
(43) Pub. Date: Jul. 1, 2004

(54) Parallel incremental compaction

(75) Inventors: Ori Ben-Yitzhak, Tivon (IL); Irit Goft, Karkur (IL); Elliot K. Kolodner, Haifa (IL); Kean G. Kuiper, Round Rock, TX (US); Victor Leikehman, Ramat Yishai (IL); Avi Owshanko, Haifa (IL)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/335,324

(22) Filed: Dec. 31, 2002

(51) Int. Cl. G06F 17/30

(52) U.S. Cl. 707/206

(57) ABSTRACT

A method for incremental compaction, including selecting a first section from a plurality of sections in a memory, and identifying references to elements in the first section. While identifying, selecting a sub-area of the first section and continuing the identifying while identifying only those references to elements in the sub-area. The method further includes holding in a data structure the identified references to elements in the first section, and if the data structure overflows, deleting from the data structure the reference elements not in the sub-area. The identifying is continued while holding in the data structure only those references to elements in the sub-area. Selecting, identifying and continuing may be performed by a plurality of threads performing the steps in parallel.

### FIELD OF THE INVENTION

The present invention relates to garbage collection in general, and more specifically to parallel incremental compaction.

### BACKGROUND

Garbage collection is the automatic reclamation of computer storage. The garbage collector's function is to find data objects that are no longer in use, and make their space available for reuse by the running program.

Consider for example FIGS. 1A and 1B, illustrations of a heap 10. Heap 10 comprises objects 12 and garbage. Objects 12 are “alive” and are directly or indirectly reachable from the roots by pointers. In contrast, garbage comprises objects that are no longer reachable from the roots and are effectively no longer in use. Objects 12 should not be collected, while garbage may be collected.

In FIG. 1B, after collection and reclaim, objects 12 have been compacted and maintained in the heap. Memory space that has just been released due to garbage collection may be allocated for new allocation requests.

As is known in the art, the act of scanning for live objects is known as marking. Marking may be done by user threads performing garbage collection or special garbage collection threads.

One known in the art garbage collection technique is “mark-sweep”. In the mark phase, the live objects are marked to distinguish them from the garbage. In the “sweep” phase, the garbage is swept away, i.e. freed and its memory added to the list of free memory.

In “stop-the-world” garbage collection marking is done with all the user threads stopped. The main disadvantage of stop-the-world garbage collection is the long disruptive pauses.

An alternative to “stopping the world” is “mostly concurrent” garbage collection. Mostly concurrent garbage collection has two phases: “concurrent” and “stop-the-world”. In the concurrent phase objects are marked concurrently with the user threads doing program work, either by user threads or by specialized background threads. During the stop-the-world phase, the user threads are stopped and objects not marked during the concurrent phase are marked.

Unfortunately, the mark-sweep family of garbage collectors may suffer from memory fragmentation. To combat fragmentation, mark-sweep collectors employ compaction. Compaction is the process of copying live objects into one contiguous region. Most existing compaction algorithms work during the stop-the-world phase of garbage collection. As a result, compaction is a major, possibly dominant, contributor to the garbage collection pause time.

To further aggravate the pause time issue, most published algorithms are inherently sequential. An example of such a method is described by F. Lockwood Morris in “A time and space efficient garbage compaction algorithm” Communications of the ACM, 21(8):662-5, 1978, included herein in reference and in its entirety. In a several gigabytes of heap memory, unfortunately the compaction process may entail several passes over the live objects, and hence, is extremely time consuming.

It is noted that there are techniques to avoid compaction. Rather than compacting each mark and sweep cycle, these techniques compact on as-needed basis. This reduces the number of long pauses due to compaction, however, does not completely eliminate compaction, or the associated pauses.

Flood et al, in their article “Parallel garbage collection for shared memory multiprocessors”, in Usenix Java Virtual Machine Reserach and Technology Symposium, (JVM '01), Monterey, Calif., April 2001, discuss a parallel compaction algorithm.

Lang and Dupont's “Incremental incrementally compacted garbage collection”, SIGPLAN'87 Symposium on Interpreters and Interpretive Techniques, volume 22(7) of ACM SIGPLAN Notices, pages 253-263, ACM Press, 1987 discuss combined mark-sweep and copying collection techniques. However, the Lang and Dupont technique it is not parallel. Additionally, Lang and Dupont must copy an object at the time the object is first marked, making their technique incompatible with mostly concurrent mark-sweep collectors.

U.S. Pat. No. 6,248,793 to Printezis, et. al. describes a method for incremental compaction. The U.S. Pat. No. 6,248,793 describes partially compacting the heap, section-by-section. Thus, for this method, the infrequent, longer, full compaction pauses are replaced with more frequent, but shorter pauses. However, if the section to be cleaned is too large, the required compaction time may exceed the time allotted for compaction. Alternatively, due to lack of appropriated space, it may not be possible to save all the references to all the referenced objects in the area to be cleaned.

As such, prior art does not discuss or offer solution to reducing the area to be compacted, or cleaned, while performing garbage collection.

### SUMMARY

In a preferred embodiment of the present invention, each time the user threads stop for collection, a section of the heap is evacuated or compacted. Thus, the present invention may section-by-section incrementally compact the heap.

One aspect of the present invention is parallel incremental compaction.

Another aspect of the present invention provides the flexibility to reduce the size of the section to be cleaned, while in the garbage collection process. Prior art incremental compaction methods do not teach or suggest methods to reduce the size of section to be cleaned.

The present invention may thereby avoid full compaction of the entire heap. In some embodiments of the present invention, incremental parallel compaction may not fully replace full compaction.

The inventors have discovered that incremental compaction may reduce maximum garbage collection pause times in three ways. 1) As noted above, incremental compaction compacts only a part of the heap each time. 2) The compaction phases may be done in parallel by all available processors. This is an advantage over prior art compaction methods which were mostly sequential, and thus did not provide for parallel compaction. 3). When used with mostly concurrent marking, the present invention may collect data for compaction concurrently with user threads doing program work.

According to one aspect of the present invention, there is therefore provided a method for incremental compaction. The method includes selecting a first section from a plurality of sections in a memory, and identifying references to elements in the first section. While identifying, the method includes selecting a sub-area of the first section and continuing the identifying while identifying only those references to elements in the sub-area.

The method further includes holding in a data structure the identified references to elements in the first section, and if the data structure overflows, deleting from the data structure the reference elements not in the sub-area. The identifying is continued while holding in the data structure only those references to elements in the sub-area. The steps of selecting, identifying and continuing may be performed by a plurality of threads performing the steps in parallel.

According to another aspect of the present invention, there is therefore provided a method for incremental compaction for garbage collection. The method includes selecting a first section from a plurality of sections in a heap, and identifying references to objects in the first section. While identifying, selecting a sub-area of the first section and continuing the identifying while identifying only those references to objects in the sub-area.

The method includes holding in a data structure addresses of locations of the identified references to objects in the first section, and if the data structure overflows, deleting from the data structure the addresses of locations that reference objects not in the sub-area. The identifying step is continued while holding in the data structure only those addresses of locations that reference objects in the sub-area.

In alternative aspects, the method further includes copying the objects from the sub area to updated locations within the sub-area and updating the identified references with the updated locations. In other alternative aspects, the method includes copying the objects from the sub area to updated locations in the heap and outside of the sub-area, and updating the identified references with the updated locations.

According to another aspect of the present invention, there is therefore provided a system for reorganizing data. The system includes means for selecting in a memory, a first section from a plurality of sections and means for identifying references to elements in the first section. While identifying, the system includes means for selecting a sub-area of the first section and means for continuing the identifying while identifying only those references to elements in the sub-area.

The system further includes means for holding in a data structure the identified references to elements in the first section. If the data structure overflows, the system comprises means for deleting from the data structure the reference elements not in the sub-area and means for continuing the identifying while holding in the data structure only those references to elements in the sub-area. The system further includes means for performing selecting, identifying and continuing by a plurality of threads in parallel.

According to yet another aspect of the present invention, there is therefore provided a computer program embodied on computer readable medium software. The computer program includes a first segment operative to select, in a memory, a first section from a plurality of sections, and a second segment operative to identify references to elements in the first section. A third segment is operative to select a sub-area of the first section while performing the second segment and a fourth segment is operative to continue the identifying while identifying only those references to elements in the sub-area.

The computer program may further include a fifth segment operative to hold in a data structure the identified references to elements in the first section and if the data structure overflows, a sixth segment operative to delete from the data structure the reference elements not in the sub-area. A seventh segment is operative to continuing the identifying step while holding in the data structure only those references to elements in the sub-area. The computer program further includes an eighth segment operative to return to the third segment and operative to select a sub-area of the sub-area and continue the computer program.

According to one aspect of the present invention, there is therefore provided an auxiliary data structure including means for fast parallel put operations, means for fast iterations over the entries, and means for overflow handling.

### BRIEF DESCRIPTION OF THE DRAWINGS

FIGS. 1A and 1B are schematic illustrations of a heap;

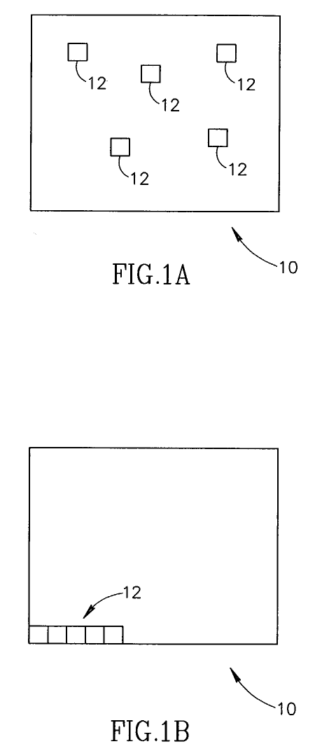

FIGS. 2A, 2B and 2C are schematic illustrations of a garbage collector, operated and constructed in accordance with a preferred embodiment of the present invention;

FIG. 3 is a flow chart that schematically illustrates a method for garbage collection, in accordance with a preferred embodiment of the present invention; and

FIG. 4 is a schematically illustration of an auxiliary data structure, operated and constructed in accordance with preferred embodiments of the present invention; and

FIGS. 5A, 5B, and 5C are schematic illustrations of data reorganization, and compaction, operated and constructed in accordance with a preferred embodiment of the present invention.

### DETAILED DESCRIPTION

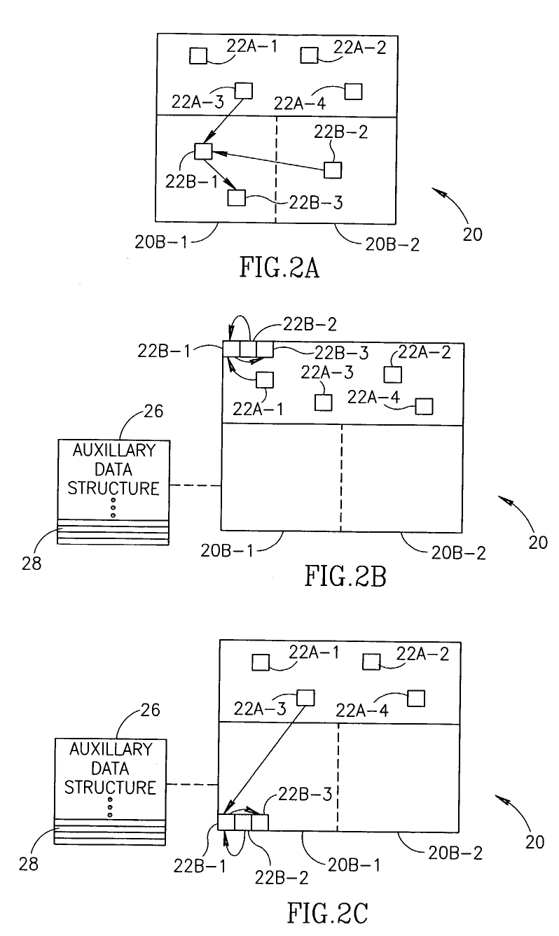

Reference is now made to FIGS. 2A-2C, illustrations of a heap 20 and further illustrating parallel incremental compaction, operated and constructed according to an embodiment of the present invention.

In FIG. 2A, heap 20 may comprise two sections, sections 20A and 20B. Section 20B may also be known as cleaned section 20B. Both sections may comprise a plurality of objects 22 and garbage. Objects 22 are reachable.

For clarity objects 22 in section A are labeled objects 22A; objects 22 in section 20B are labeled objects 22B. To assist identification, objects 22 are numbered, i.e., 22A-1 and 22B-2. As is common in the art, one or more objects 22A may reference or point to objects 22B, e.g., object 22A-3 references object 22B-1.

FIG. 2B illustrates one preferred embodiment of the present invention. After collection and reclaim, section 20B is cleaned or evacuated, however, in contrast, section 20A is not cleaned. Section 20A may be swept to identify free areas, and then objects 22B may be moved to those free areas in section 20A. The memory space in section 20B may be released for new allocation requests.

FIG. 2C illustrates an alternative preferred embodiment of the present invention. After collection and reclaim, again only section 20B is compacted. However, objects 22B are not moved from section 20B, rather, compacted within section 20B. The remaining memory space in section 20B is released for new allocation requests.

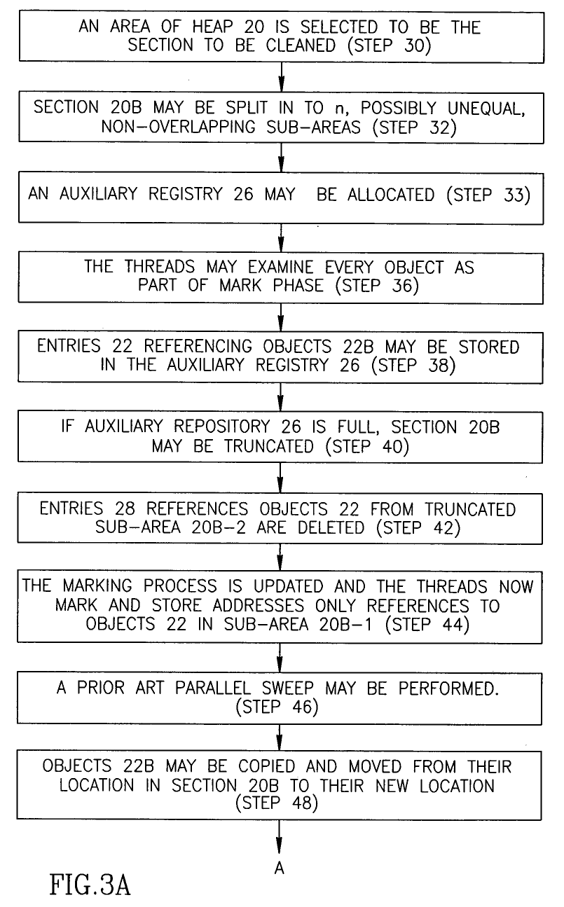

Reference is now made to FIG. 3, a flow chart illustrating one preferred method for implementing an embodiment of the present invention. Please refer to FIG. 3 in parallel with FIGS. 2A-2C.

FIG. 3 details six phases of a preferred embodiment: Initialization, mark, sweep, evacuate/compact, fix-up and rebuild. It is noted that the six phases are meant to be descriptive and not limiting. Alternative embodiments may comprise fewer or more phases, while still abiding with the principles of the present invention.

Initialization: An area of heap 20 is selected (step 30) to be the section to be cleaned. In this example, the selected section is section 20B. Preferably, the threads designated to perform marking are aware of the sections 20A and 20B, and are aware of that section 20B is selected to be cleaned.

Section 20B may then be split (step 32) into n, possibly unequal, non-overlapping sub-areas. Each sub-area may be numbered 1 to n, i.e., sub-area 20B-1.

In some preferred embodiments of the present invention, an auxiliary data structure 26 may be built (step 34). Typically a limited space is set-aside for auxiliary data structure 26. Auxiliary data structure 26 may hold a plurality of entries 28. Entries 28 may contain the addresses of locations that reference objects 22B. In some alternative embodiments, entire 28 may contain addresses of objects 22B.

It is noted that initialization should occur before the start of the mark phase.

Mark: As is known in the art, threads (not shown) performing garbage collection may perform the marking process. In step 36, the threads performing garbage collection may examine every object, i.e., when it is popped from the mark stack, and its references are scanned for as yet unmarked objects. When the threads identify a location referencing an object 22B, the thread may store the addresses of that location as entries 28 (step 38).

In further alternative embodiments of the present invention, several threads may mark in parallel. As such, both mostly concurrent and stop-the-world threads may be marking and putting in parallel. The threads may also gather the addresses in parallel. It is noted that most of the gathering of addresses may occur during the concurrent mark phase, and hence may not significantly add to the pause times for mostly concurrent collection.

At this point in the mark phase, in some instances, auxiliary data structure 26 may be full. This may occur if there are too many entries 28 and there is longer any room to store more entries 28. Alternatively, the time needed to incrementally compact the selected section may be larger than the allotted time. In a preferred embodiment of the present invention, when auxiliary data structure 26 is full, section 20B may be truncated (step 40). In such cases, one of the sub-areas, 20B-1 or 20B-2, may be selected to be the section to be cleaned, i.e., sub-area 20B-1.

Entries 28 containing reference to objects 22B in sub-area 20B-2 are deleted (step 42), e.g., entries 28 containing reference object 22B-2. Entries 28 referencing objects 22B in sub-area 20B-1 are retained.

The threads performing garbage collections may be made aware of the update, and that only sub-area 20B-1 is to be cleaned. In a preferred embodiment of the present invention, the marking process is updated (step 44). The threads now store only the entries 28 appropriate for sub-area 20B-1.

It is appreciated by those skilled in the art that various steps in this phase, and in other phases of the present invention, may be repeated until the task in relevant step is completed. As an example, step 44 may be repeated until all the appropriate objects are marked. Accordingly, steps 44 (marking and storing), 48 (copying and moving) and 50 (placing forwarding pointers) may also repeated until the tasks therein are completed.

It is thus noted that the present invention provides for a multiplicity of threads identifying and putting in parallel. The present invention further provides for reducing the size of the section to be cleaned while in the midst of performing garbage collection.

Sweep: A prior art parallel sweep (step 46) may be performed.

Evacuate/Compact: Objects 22B may be copied (step 48) and moved from their original location in section 20B to their new location. For the embodiment illustrated in FIG. 2B, evaluation, forwarding pointers (step 50) may be placed in the original locations.

In a preferred embodiment, a plurality of objects 22B may be copied in parallel. Section 20B may be split into a plurality of parts. A plurality of dedicated threads may each be associated with one of the parts. Each dedicated thread may evacuate its own associated part. Space allocation for the evacuated objects may be performed by any prior art allocation technique. There are known allocation techniques that perform parallel allocation request optimization.

It is noted that in FIG. 2B, objects 22B are evacuated to section 20A. In contrast, in FIG. 2C, objects 22B are moved within section 20B. Both techniques are covered within the principles of the present invention.

Fix up: The threads performing compaction may scan (step 52) auxiliary data structure 26. The threads may additionally scan the roots. The threads may replace (step 54) the held references with new references directed to the updated location of the relocated object 22B. If the root points to an object 22B formerly from section 20B, the forwarding pointer in the object 22B may be used to update the root.

For addresses of object 22B held in auxiliary data structure 26, the forwarding pointer from the object 22B may be used to find the new location of the relocated object 22B. The fields in the copied object 22B may be updated. For addresses of an object 22A referencing object 22B, the contents of the field may be used to find (step 56) the forwarding address in the section 20B.

In preferred embodiments, steps 52 to 56 may be performed in parallel by a plurality of threads thereby taking advantage of the fast parallel iteration over auxiliary data structure 26.

At this point, in preferred embodiments auxiliary data structure 26 may be deleted.

Rebuild: In the embodiment of the present invention illustrated in FIG. 2B, section 20B may be swept (step 58), reclaiming the memory space. Prior art sweep methods may be used. Areas of free memory may be added to a free list at the appropriate places. This step may be accomplished in parallel using the same logic as parallel sweep.

In the embodiment illustrated in FIG. 2C, section 20B may be compacted (see section Evacuate/Compact hereinabove).

It is thus shown that by performing the steps, the present invention may incrementally compact the heap, section by section. The incremental compaction pauses may be shorter than the prior art full compaction pauses. Furthermore, many of the actions in the present invention may be performed in parallel, providing for even shorter pause times.

It is additionally noted that the present invention provides the flexibility to reduce the size of the section to be cleaned, while performing garbage collection.

Auxiliary data structure 26

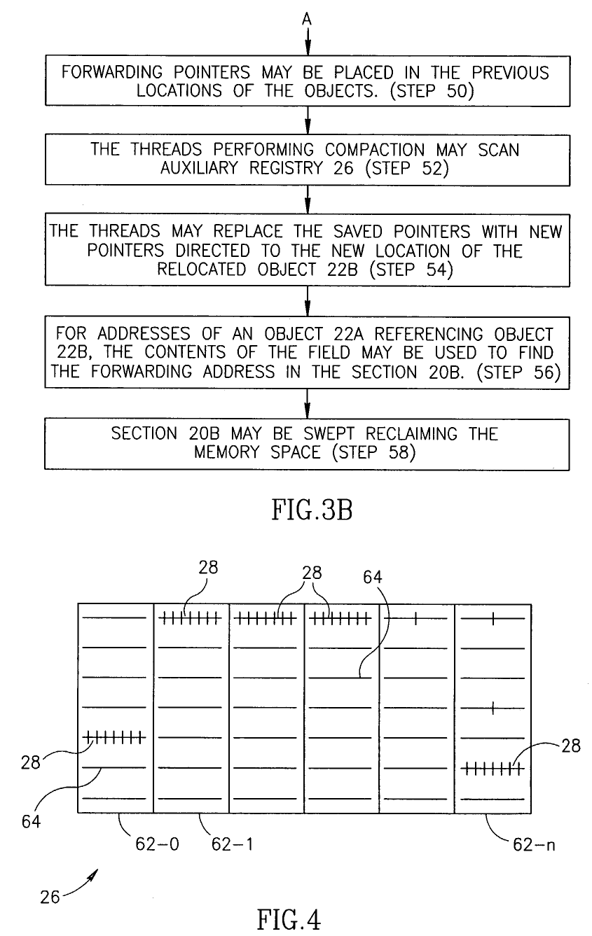

The structure and implementation of auxiliary data structure 26 will now be explained in detail. Reference is now made to FIG. 4. For clarity, please refer in parallel to FIGS. 2A-2C.

Structure: In a preferred embodiment of the present invention, auxiliary data structure 26 may be a dedicated data structure for holding entries 28. Auxiliary data structure 26 may allow for 1) fast parallel put operations, 2) fast iterations over the entries 28 and 3) overflow handling. Each of these points will be discussed in detail hereinbelow in appropriately marked sections.

Implementation: The auxiliary data structure 26 may comprise a plurality of linked lists 62 of buffers 64. Each buffer 64 may comprise a fixed amount of entries 28. One of the lists 62 may hold empty buffers 64, and the others lists 62 may hold full buffers 64.

Please refer briefly to the above discussion in Initialization phase, and specifically step 32, the creation of n sub-areas. In preferred embodiments, auxiliary data structure 26 may comprise n+1 lists 62, referenced herein as lists 62-0, 62-1, 62-n, and so on.

List 62-0 may hold empty buffers 64. List 62-i may correspond to sub-area 20B-i. Buffers 64 in list 62-i contain only entries 28 referencing objects 22 in sub-area 20B-i.

Buffers 64 may be allocated during the initialization phase, and recycled at the end of the evacuate/compact phase. In preferred embodiments, more buffers 64 may be allocated during the mostly concurrent collection. However, if all the buffers 64 where used up during the stop-the-world mark phase, auxiliary data structure 26 may overflow. Methods to handle overflow are described herein in the overflow handling section.

Fast parallel Put Operations.

Structure: As noted above, during the mark phase entries 28 may be “put” into auxiliary data structure 26. (see steps 38-38) Both mostly concurrent and stop-the-world threads may be marking and putting in parallel. There is therefore a possibility that two or more threads will put into auxiliary data structure 26 at the same time. In preferred embodiments of the present invention, put operations may be thread-safe. In order to avoid slowing down the mark phase, the put operations may preferably be as fast as possible.

Implementation: Each marking thread may hold up to n buffers 64: one buffer 64 for each sub-area 20B-i.

In some cases, the thread may find a location referencing an object 22B. The thread may determine which sub-area 20B the reference points. The thread may the provide the appropriate entry 28 to the put operation to be added to the appropriate buffer 64.

Buffers 64 are local to the thread, therefore the put operation may be fast and may not require any synchronization. When a thread's buffer 64 is full, the thread inserts the full buffer 64 in the appropriate corresponding list 62-i. The thread may then obtain a new buffer 64 from the free list 62-0.

The list operations may be done using atomic compare-and-swap, and thus may be fast and require minimal synchronization.

Fast parallel iteration over auxiliary data structure 26 entries.

Structure: During the Fix up phase, preferred embodiments may provide for fast iteration over entries 28.

As noted, a plurality of threads may be working in parallel to retrieve references stored in entries 28 and using the held references, locate the relocated object (see steps 52-54). Auxiliary data structure 26 may lock if two or more threads attempt to simultaneously retrieve the same address. Therefore, auxiliary data structure 26 may provide for fast parallel iteration over its entries.

Implementation: Buffers 64 may enable fast parallel iteration over entries 28. A fix up thread may remove buffers 64 from lists 62 using atomic compare-and-swap operations. The fix up thread may then iterate over the entries 28 in removed buffers 64.

Overflow Handling.

Structure: Preferred embodiments of the present invention may provide a data structure of fixed capacity. In case of an overflow in auxiliary data structure 26, section 20B may be truncated, and entries 28 referencing objects 22B in the truncated parts of the section 20B may be removed from the auxiliary data structure 26 (see steps 40-44).

In some embodiments, section 20B can be truncated several times. If auxiliary data structure 26 overflows more than an allowed number of times, incremental compaction may be aborted. To handle this condition, please refer to the next section “implementation”.

Implementation: Auxiliary data structure 26 may be “overflowed” when a marking thread cannot acquire a new buffer (see Fast parallel iteration over auxiliary data structure 26 entries, section “implementation). To correct this problem, section 20B may be truncated (see step 40).

Truncation may occur by excluding from the section 20B the highest numbered sub-area, i.e., sub-area 20B-2, and moving its corresponding buffers 62 to list 62-0, the free list.

In an alternative embodiment, data structure 26 may be implemented using a mapping data structure such as a bitmap.

Policies

Preferred embodiment of the present invention may be augmented by a set of policies to control triggering, the choice of the section to be cleaned, and object relocation behavior. The inventors have discovered that even a set of naive policies may shorten the maximum pause time, while incurring minimal performance penalty.

In preferred embodiments of the present invention, incremental parallel compaction may not fully replace the full compaction, rather complements it. Hence full compaction may still be performed, although infrequently. Policies for triggering full compaction may be as follows:

1) When allocation fails just after a sweep. This is typically a last resort measure.

2) When the amount of free space after sweep is below a threshold. In preferred embodiment, the threshold may be 4% of the heap.

Other preferred embodiments may employ a policy to control selection of the area to be cleaned. The area chosen may be a sliding window of 1/14 of the heap. The area to be cleaned may be divided into 4 equal sub-areas.

Other preferred embodiments may employ a policy to control object relocation. In some embodiment a prior art allocator optimized for satisfying simultaneous requests is used. The allocator may allocate small objects from per-thread allocation caches. The policy for allocating these caches may be address-ordered first fit. Thus live objects are copied to the lowest part of memory available for a cache. Typically, the present invention may avoid moving large objects, because their effect on fragmentation may be minimal, and the cost of copying them may be significant.

The present invention may be implemented in a non-generational system. Alternatively, the present invention may be implemented together with a generational collector wherein old area may be collected using the mark-sweep technique. The present invention may also be implemented with mostly concurrent collectors.

Although the present invention has been explained with reference to garbage collection, it is apparent to those skilled in the art that incremental compaction may be especially beneficial for compacting or reorganizing any type of memory holding graph-like data structures. Examples of graph-like data structures may be a file system or a mail file.

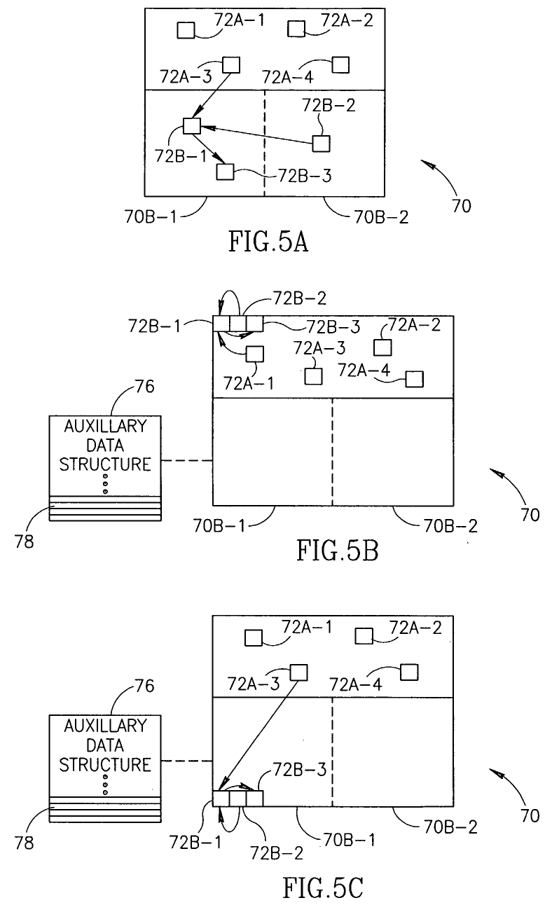

Reference is now made to FIG. 5, a mail file 70 operated and constructed according to an alternative embodiment of the present invention. Mail file 70 may comprises a plurality of e-mails and folders 72. E-mails and folders 72 may reference each other. While referring herein to elements such as e-mails, and folders, it is apparent to those skilled in the art that other mail elements are covered within the principles of the present invention. One way of referencing may be via discussion thread or common “subject” title. Another way of referencing may be common placement is a folder 72.

Mail file 70 may be divided into two or more sections, A and B respectfully. Each section 70A and 70B may be divided into two or more subsections, -1 and -2 respectively.

An auxiliary data structure 76 may be used when compacting mail file 70. Auxiliary data structure 76 may comprise entries 78. Entries 78 may hold indications of the references noted above.

At some point it may be desirable to compact or reorganize mail file 70. As an example, due to a limited hard drive space, it may be desirable to archive or delete a portion of e-mails and folders 72. After completion of the compaction or reorganization it is desirable that the references from e-mails and folders 72 to e-mails and folders 72 still be correct.

Consequently, according to a preferred embodiment of the present invention, a plurality of threads may commence cleaning section 70B according to the process described hereinabove in reference to FIGS. 2-4. References between the e-mails and folders 72 may be stored as entries 78.

As a point in the cleaning process, auxiliary data structure 76 may become full. Alternatively, the expected compaction phase may be longer than a predetermined deadline. Subsequently, it is desired to reduce the size of the area to be cleaned.

It is noted, that there may be various factors initiating the decision to reduce the area to be cleaned. As noted, one reason may be lack of further storage space auxiliary data structure 76. An alternative reason may be exceed a predetermined time limit for the cleaning/compacting process. These reasons are by way of example only, and it is appreciated that other limiting factors may be occur to those skilled in the art that, while not specifically shown herein, are nevertheless within the true spirit and scope of the invention.

Sub-section 70B-1 may be selected as the area to be cleaned. Entries 78 not referencing e-mails or folders 72 in sub-section 70B-1 may be deleted from auxiliary data structure 76. The threads may continue the cleaning process identifying only those references e-mails or folders 72 in sub-section 70B-1.

The present embodiment is then continued with the appropriate identifying copying, relocating, referencing, compacting, etc. processes, similar to those described in detail above in reference to FIGS. 2-4.

It is apparent to those skilled in the art that while FIG. 5 illustrates mail file 70, the reference is by way of example only, and any graph-like data structure that may require reorganization or compaction is covered by the principles of the present invention. An example of such may include be the requirement to reorder the memory layout of a data structure.

It is additionally apparent to those skilled in the art that while the present invention refers herein to elements such as data objection in garbage collection, and mail elements, other elements held in graph like data structures are covered within the principles of the present invention.

It is appreciated that those skilled in the art that may be aware of various other modifications, which while not specifically shown herein, are nevertheless within the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A method for incremental compaction, the method comprising the steps of:
in a memory, selecting a first section from a plurality of sections;
identifying references to elements in said first section;
while identifying, selecting a sub-area of said first section; and
continuing said identifying step while identifying only those references to elements in said sub-area.

2. The method of claim 1, and further comprising the steps of:
holding in a data structure said identified references to elements in said first section;
if said data structure overflows;
deleting from said data structure said reference elements not in said sub-area; and
continuing said identifying step while holding in said data structure only those references to elements in said sub-area.

3. The method of claim 1, wherein said steps of selecting, identifying and continuing are performed by a plurality of threads performing said steps in parallel.

4. A method for incremental compaction for garbage collection, the method comprising the steps of:
in a heap, selecting a first section from a plurality of sections;
identifying references to objects in said first section;
while identifying, selecting a sub-area of said first section; and
continuing said identifying step while identifying only those references to objects in said sub-area.

5. The method of claim 4, and further comprising the steps of:
holding in a data structure addresses of locations of said identified references to objects in said first section;
if said data structure overflows;
deleting from said data structure said addresses of locations that reference objects not in said sub-area; and
continuing said identifying step while holding in said data structure only those addresses of locations that reference objects in said sub-area.

6. The method of claim 4, wherein said steps of selecting, identifying and continuing are performed by a plurality of threads performing said steps in parallel.

7. The method of claim 4, and further comprising the steps of:
copying said objects from said sub area to updated locations within said sub-area; and
updating said identified references with said updated locations.

8. The method of claim 4, and further comprising the steps of:
copying said objects from said sub area to updated locations in said heap and outside of said sub-area; and
updating said identified references with said updated locations.

9. A system for reorganizing data, the system comprises:
means for selecting in a memory, a first section from a plurality of sections;
means for identifying references to elements in said first section;
while identifying, means for selecting a sub-area of said first section; and
means for continuing said identifying while identifying only those references to elements in said sub-area.

10. The system of claim 9, and further comprising:
means for holding in a data structure said identified references to elements in said first section;
if said data structure overflows;
means for deleting from said data structure said reference elements not in said sub-area; and
means for continuing said identifying while holding in said data structure only those references to elements in said sub-area.

11. The system of claim 9, and further comprising:
means for performing selecting, identifying and continuing by a plurality of threads in parallel.

12. A system for incremental compaction for garbage collection, the system comprises:
means for selecting a first section from a plurality of sections in a heap;
means for identifying references to objects in said first section;
while identifying, means for selecting a sub-area of said first section; and
means for continuing said identifying while identifying only those references to objects in said sub-area.

13. The method of claim 12, and further comprising the steps of
means for holding in a data structure addresses of locations of said identified references to objects in said first section;
if said data structure overflows;
means for deleting from said data structure said addresses of locations that reference objects not in said sub-area; and
means for continuing said identifying while holding in said data structure only those addresses of locations that reference objects in said sub-area.

14. The system of claim 12, and further comprising:
means for copying said objects from said sub area to updated locations within said sub-area;
means for updating said identified references with said updated locations; and
means for compacting said sub-area.

15. The system of claim 12, and further comprising:
means for copying said objects from said sub area to updated locations in said heap and outside of said sub-area; and
means for updating said identified references with said updated locations.

16. The system of claim 12, and further comprising:
means for performing selecting, identifying and continuing by a plurality of threads in parallel.

17. A computer program embodied on computer readable medium software, the computer program comprising:
a first segment operative to select, in a memory, a first section from a plurality of sections;
a second segment operative to identify references to elements in said first section;
while performing said second segment, a third segment operative to select a sub-area of said first section; and
a fourth segment operative to continue said identifying while identifying only those references to elements in said sub-area.

18. The computer program of claim 17, and further comprising:
a fifth segment operative to hold in a data structure said identified references to elements in said first section;
if said data structure overflows;
a sixth segment operative to delete from said data structure said reference elements not in said sub-area; and
a seventh segment operative to continuing said identifying step while holding in said data structure only those references to elements in said sub-area.

19. The computer program of claim 18, and further comprising:
an eighth segment operative to return to said third segment and operative to select a sub-area of said sub-area and continue said computer program.

20. An auxiliary data structure comprising
means for fast parallel put operations;
means for fast iterations over the entries; and
means for overflow handling.
